(19) United States
(12) Patent Application Publication
(10) Pub. No.: US 2016/0167353 A1
(43) Pub. Date: Jun. 16, 2016

(54) SYSTEMS AND METHODS FOR JOINING COMPONENTS

(71) Applicant: GM GLOBAL TECHNOLOGY OPERATIONS LLC, DETROIT, MI (US)

(72) Inventors: HUA-TZU FAN, TROY, MI (US); CHEN-SHIH WANG, TROY, MI (US); JORGE F. ARINEZ, ROCHESTER HILLS, MI (US); SUSAN M. SMYTH, ROCHESTER HILLS, MI (US)

(73) Assignee: GM GLOBAL TECHNOLOGY OPERATIONS LLC

(21) Appl. No.: 14/568,363

(22) Filed: Dec. 12, 2014

(51) Int. Cl. B32B 37/04

(52) U.S. Cl. CPC B32B 37/04; B32B 2310/00

(57) ABSTRACT

The present technology discloses methods for joining a first workpiece and a second workpiece through an interlocking weld, and products formed thereby. The first workpiece has a first surface and a second surface opposite the first surface, and the second workpiece has a first surface, a groove formed in the first surface, and a second surface opposite the first surface. The system is formed by applying energy to the system, at least partially melting material of the first workpiece, and causing the material to flow into the groove, and allowing or causing the material to cool, forming an interlocked-weld joint connecting the workpieces.

### TECHNICAL FIELD

The present technology relates generally to joining components. More specifically, the present technology relates to systems and methods for interlocking components being joined.

### BACKGROUND OF THE DISCLOSURE

Joining workpieces with similar or dissimilar material properties has become increasingly important as industries strive for reduced weight and improved performance from engineering structures such as automotive, aeronautical, and nautical, among others.

Processes for joining similar or dissimilar materials include mechanical joining (e.g., bolts and rivets), fusion joining (e.g., fusion arc welding and laser welding), solid-state joining (e.g., friction-stir welding and ultrasonic welding), brazing and soldering, and adhesive bonding, among others.

Joining dissimilar materials presents challenges due to different chemical, mechanical, and thermal behaviors of materials that are not present when joining similar materials. When designing a dissimilar-material joint, factors such as, but not limited to, material thicknesses, surface energy, differences in melting temperature, thermal expansion/contraction of each material must be taken into consideration. Even taking the aforementioned factors into consideration, joining techniques such as welding and soldering provide surface bonding that can be prone to failure under certain directional loads such as peel stress.

Joining dissimilar materials includes challenges such as avoiding distortion and stress that tend to form within the materials due to differing coefficients of thermal expansion. These unwanted conditions can cause stress corrosion cracking, which weakens the bond and can lead to premature failure of the joint.

Other methods to join dissimilar materials use fasteners such as adhesives, rivets, and bolts. However, these fasteners lead to issues such as structural breakdown of the adhesives and galvanic corrosion of the rivets and bolts. Additionally, these fasteners add a relatively-large amount of weight, which is contrary to trends towards lighter components in most industries.

### SUMMARY OF THE DISCLOSURE

Due to the aforementioned deficiencies, the need exists for systems and methods to join securely workpieces that contain dissimilar materials without added fasteners such as adhesives, rivets, or bolts. The proposed systems and methods would join the workpieces by mechanically interlocking the materials of the workpieces according to unique techniques that do not use additional fasteners.

The present technology includes a system by which mechanical interlocking is accomplished through forming grooves at a joint interface of at least one of the workpieces. The grooves are configured to receive melted material from the joining workpiece for forming a robust joint when the melted material cools.

In some embodiments, the materials joined are similar in composition. In these embodiments, the grooves can be formed in either or both of the workpieces. In one embodiment, a first workpiece is configured to melt and fill the grooves of the second workpiece. As the first workpiece fills the grooves of the second workpiece, the grooves slightly melt to increase interlock at the joint.

In other embodiments, the materials joined are dissimilar in composition. In these embodiments, the grooves should be formed within the material having the highest melting temperature. Forming grooves into the workpiece having the higher melting temperature allows the material having the lower melting temperature to melt and flow into the grooves. In some implementations for joining components having dissimilar composition, depending, for instance, on the a value of the higher melting point and a temperature of the molten material from the lower-melting-point component, the molten material could flow into the grooves without deforming the grooves, or only deforming the grooves slightly. While in some cases deforming grooves can be beneficial by promoting interlock as referenced above, maintaining groove structure substantially or entirely can also, based on groove shape, groove dimensions, and materials, for instance, promote interlocking and formation of stronger welds compared with welding without the use of grooves.

Another of many benefits of the present technology includes the ability to form a joining interfaces having minimal or no negative affect on an appearance of at least one of the surfaces opposite the joint interface.

In some embodiments, negative impact on appearance of at least one of the surfaces opposite the joint interface is minimized or avoided completely by using laser heating to melt the material of one of the workpieces to be introduced to grooves of the other workpiece. In other embodiments, the negative impact is limited or avoided by using induction heating to melt the workpiece opposite the grooves.

Other aspects of the present technology will be in part apparent and in part pointed out hereinafter.

### DESCRIPTION OF THE DRAWINGS

FIG. 1 illustrates a cross-sectional view of example joining systems for producing a robust interlock between a first workpiece and a second workpiece.

FIG. 2 illustrates a cross-sectional view of a laser-heating joining process using a portion of one of the example joining systems of FIG. 1.

FIG. 3 illustrates a cross-sectional view of an induction-heating joining process using another portion of the example joining systems of FIG. 1.

FIG. 4 illustrates a cross-sectional view of an ultrasonic-heating joining process using another portion of the example joining systems of FIG. 1.

FIG. 5 illustrates a top view of exemplary patterns formed by a joining system of FIG. 1.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, illustrative, and similar terms, refer expansively to embodiments that serve as an illustration, specimen, model or pattern.

The figures are not necessarily to scale and some features may be exaggerated or minimized, such as to show details of particular components. In some instances, well-known components, systems, materials or methods have not been described in detail in order to avoid obscuring the present disclosure. Specific structural and functional details disclosed herein are therefore not to be interpreted as limiting, but merely as a basis for the claims and as a representative basis for teaching one skilled in the art to variously employ the present disclosure.

### I. OVERVIEW OF THE TECHNOLOGY

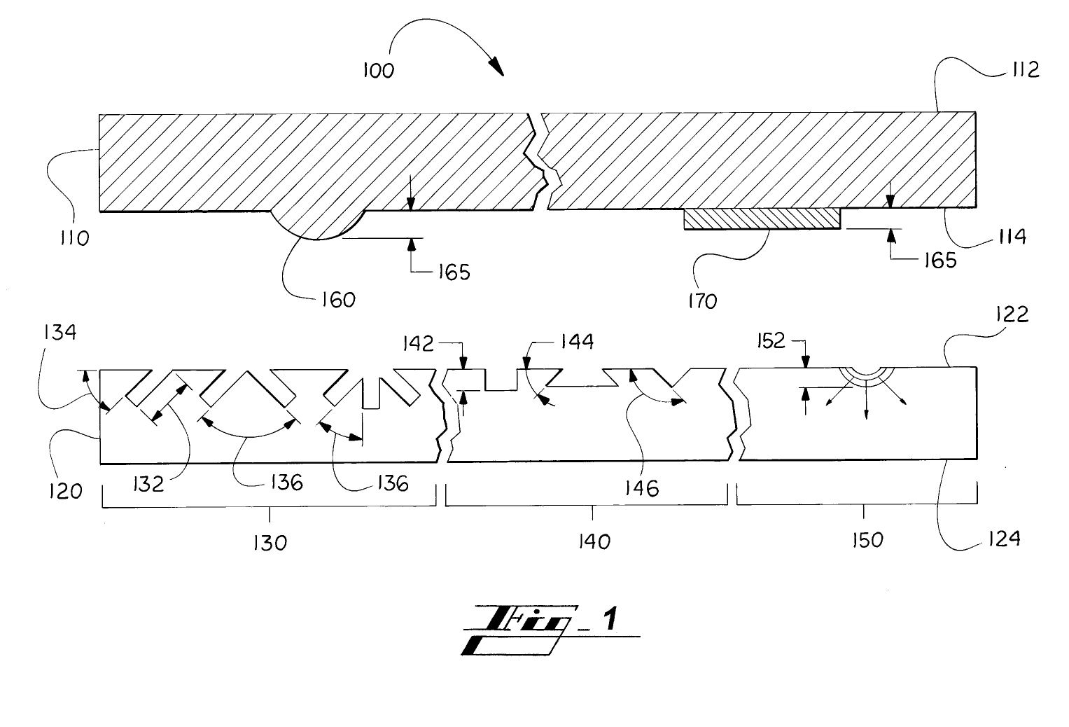

### FIG. 1

FIG. 1 illustrates a joining system 100 including a first workpiece 110 and a second workpiece 120. The first workpiece 110 and the second workpiece 120 may be similar in material structure. For example, the first workpiece 110 and the second workpiece 120 may both be composed of a polymer composite material. Conversely, the first workpiece 110 can be of a different material than the second workpiece 120. For example, the first workpiece 110 may be a composite material, while the second workpiece 120 may be an aluminum alloy.

In some embodiments, at least one of the workpieces 110, 120 include a polymer such as polycarbonate, polyolefin (e.g., polyethylene and polypropylene), polyamide (e.g., nylons), polyacrylate, or acrylonitrile butadiene styrene.

In some embodiments, at least one of the workpieces 110, 120 include a composites such as a reinforced thermoplastic. The plastics may include any of the exemplary polymers listed above, and the reinforcement may include one or more of clay, glass, carbon, polymer in the form of particulate, fibers (short or long), platelets, and whiskers, among others.

The first workpiece 110 includes a first surface 112 and a second surface 114, and the second workpiece 120 includes a first surface 122 and a second surface 124. In one embodiment, the first workpiece 110 is positioned above the second workpiece 120 for joining, in which case the second surface 114 of the first workpiece 110 and the first surface 122 of the second workpiece contact upon joining.

To create enhanced interlock between the workpieces 110, 120 at least one groove is formed within a joining surface of the workpieces 110, 120 (e.g., the second surface 114 of the first workpiece 110 or the first surface 122 of the second workpiece 120). The groove(s) form a cavity within the workpieces 110, 120 are configured to receive melted material from the joining workpiece.

Grooves can be formed within either workpiece where the first workpiece 110 and the second workpiece 120 are made of similar materials. Similarity of the workpieces 110, 120 may be on characteristics such as, but not limited to, whether the workpieces 110, 120 are composed of the same material composition, have similar coefficient of thermal expansion, or have similar melting points.

In an embodiment in which the workpieces 110, 120 comprise similar materials, the first workpiece 110 is configured to melt and fill the grooves of the second workpiece 120. As material of the first workpiece 110 increases in temperature (due, e.g., to ultrasonic energy and/or compressional force used to join the workpieces 110, 120), the material of the first workpiece 110 melts and begins to fills the grooves of the second workpiece 120.

As the grooves of the second workpiece 120 begin to fill with melted (e.g., molten) material flowing from the first workpiece 110, walls of the grooves, which are defined by the cavity, may slightly soften (e.g., melt). At least some of the wall material is softened before the molten material from the first workpiece flows in the groove in the second workpiece 120. Slight softening of the groove wall(s) may provide additional interlock at the joint interface because the two separate surfaces (e.g., melting surface of the first workpiece 110 and softening surface of the groove) interact more than the surfaces would if the groove wall did not melt, cool to form a highly joined interface.

In some implementations of the embodiment, some of the materials of the first workpiece 110 and the second workpiece 120 intermix in the groove to form enhanced interlocking of the second surface 114 of the first workpiece 110 and the first surface 122 of the second workpiece 120. In an implementation, the second surface 114 of the first workpiece 110 and the first surface 122 of the second workpiece 120 join to form a connection in the groove lacking distinguishable surfaces that would be present if the materials did not meld together in the area.

When the first workpiece 110 and the second workpiece 120 comprise dissimilar materials, the grooves should be formed within the material with the highest melting temperature. For example, when bonding a metal workpiece, which can have a melting temperature of 600 to approximately 1200° C., with a thermoplastic workpiece, which can have a melting temperature between approximately 100 and approximately 300° C., the grooves should be formed within the metal workpiece. The thermoplastic workpiece will melt at a lower temperature than the metal workpiece causing thermoplastic material to flow into the grooves formed within the metal workpiece.

Grooves can be created using mechanical methods (e.g., sawing and stamping), electrical methods (e.g., laser and electrical discharge machining (EDM)), chemical methods (e.g., etching), among others. In the exemplary embodiment of FIG. 1, the first workpiece 110 has a lower melting temperature than the second workpiece 120. Thus, the grooves are formed within the second workpiece 120. Conversely, if the second workpiece 120 had a lower melting temperature than the first workpiece 110, the grooves would be formed within the first workpiece.

A slot groove 130 can be inserted into the second workpiece 120 using a laser, EDM, or other machining of incisions. The slot groove 130 provides additional interlock of the first workpiece 110 with the second workpiece 120. As the first workpiece 110 is heated during bonding, the material begins to melt and fills the slot groove.

Illustrated as the first slot groove 130 in FIG. 1, a one-sided slot groove is beneficial when the joint is designed to withstand a load strength in a particular direction. For example, a one-sided slot groove may be used where the slot grove 130 is inserted into the first workpiece 110 in a pre-determined direction.

The slot groove 130 has a length 132 sufficient to receive material from the first workpiece 110. The length 132 of the slot groove 130 may be between approximately 10 microns (μm) and approximately 1000 millimeters (mm).

The slot groove 130 is formed at an angle 134 to the joining surface of the workpiece (e.g., the first surface 122 of the second workpiece 120). The angle 134 enhances interlock of the melted material from the first workpiece 110 with the voids created by the slot groove 130. The angle 134 may provide additional structure to strengthen the joint from fracture (e.g., peel fracture).

The angle 134 can have a range between 0 and 90 degrees from the first surface 122. In some embodiments, the angle 134 may be between approximately 30 and 60 degrees. In some embodiments, the angle 134 may be approximately 45 degrees.

In some embodiments, two or more slot grooves 130 are positioned to overlap creating an opening for increased contact surface area for receiving material from the first workpiece 110 upon melting (illustrated as the second and third slot groove 130 in FIG. 1). Increasing contact surface area during bonding can improve the strength of the bond after joining.

In multi-slot groove embodiments, each slot groove 130 can be positioned relative to the first surface 122 (e.g., the angle 134). A first slot groove 130, in multi-slot groove embodiments, can have a side extending at a first angle from the first surface 122 of the second workpiece 120. The first angle can for example range between 0 degrees and 90 degrees. A second slot groove 130 can have a side extending at a second angle from the first surface 122 of the second workpiece 120, forming overlap with the first slot groove 130. The second angle for example can range between 90 degrees and 180 degrees.

Additionally or alternatively, each slot groove, in multi-slot groove embodiments, can be positioned in reference to the other slot grooves 130 (e.g., an angle 136). The angle 136 for example can range between 0 and 180 degrees.

Additionally in the multi-slot groove embodiment, at least one of the slot grooves 130 may have the length 132. Alternatively, at least one of the slot grooves 130 may vary in length between approximately 10 μm and approximately 1000 mm.

A shaped groove 140 can be inserted into the second workpiece 120 using stamping or other mechanical and/or electrical manufacturing process. As seen in FIG. 1, the shaped groove 140 can be formed according to varying geometric shapes such as, but not limited to square, triangle, trapezoid, circular, and oval. The shaped groove 140, similar to the slot groove 130, provide additional interlock with between the workpieces 110, 120.

The shaped groove 140 can have a depth 142 into the second workpiece 120. The depth should be sufficient to receive material from the first workpiece 110 (e.g., between approximately 10 μm and approximately 100 mm).

In some embodiments, the shaped groove 140 is positioned at an angle to the first surface 122 of the second workpiece 120. For example, if the shaped groove 140 is in the form of a trapezoid, an angle 144 to the first surface 122 can be an acute angle. However, where the shaped groove 140 is in the form of an inverted triangle, an angle 146 to the first surface 122 can be an obtuse angle.

An etched groove 150 can be inserted to the second workpiece 120 using chemicals (e.g., acid and mordant) to cut into the first surface 122. The etched groove 150 may be formed with or without an etch mask (not shown).

Where etching forms an indentation, as seen in FIG. 1, a depth 152 of the indentation may be controlled using a known etch time and a known etch rate of the etchant. In some embodiments, the etched groove 150 undercuts the etch mask and form an indentation with sloping sidewalls. The depth 152 should be sufficient to receive material from the first workpiece 110 (e.g., between approximately 10 μm and approximately 100 mm).

The etched groove 150 can be formed using a liquid-phase wet etchant (e.g., buffered hydrofluoric acid (HF), phosphoric acid (H₃PO₄), and nitric acid (HNO₃)), or a plasma-phase dry etchant (e.g., carbon tetrachloride (CCl₄), silicon tetrachloride (SiCl₄), and boron trichloride (BCl₃)), or other etchant. For example, the etched groove 150 may be formed using an isotropic process or an anisotropic process including phosphoric acid, where the second workpiece 120 is aluminum in composition.

In some embodiments the groves 130, 140, 150 form a continuous groove through a length (not shown) of the first workpiece 110 or the second workpiece 120. Continuous grooves may be desirable where continuous joining is desired between the first workpiece 110 and the second workpiece 120. For example continuous contact may be desired where the workpieces 110, 120 are subject to conditions of shear force and/or peel force.

In some embodiments, additional material is added to the workpiece with the lower melting temperature (e.g., the first workpiece 110 in FIG. 1). The additional material can be provided, for example, as one or more protrusions extending from one or both surfaces of the first workpiece. Where the grooves 130, 140, 150 are of a particular length and/or depth, the first workpiece 110 may not contain sufficient material to fill the grooves 130, 140, 150, leaving the first surface 112 of the first workpiece 110 with sink marks after joining. To avoid sink marks on the first surface 112, the first workpiece 110 can include additional material to fill the grooves 130, 140, 150.

The additional material can be positioned at a location that corresponds to the grooves 130, 140, 150 on the second workpiece 120, thus allowing the additional material to flow directly into the grooves 130, 140, 150.

In one embodiment, the additional material includes a cast material 160, which can be molded directly onto the second surface 114 of the first workpiece 110. In another embodiment, the additional material can include a separate material 170, which can be affixed to the second surface 114 of the first workpiece 110 during a manufacturing process. Alternatively, the separate material 170 may be introduced during joining.

The cast material 160 and/or the separate material 170 have a thickness 165 that is sufficient to fill the grooves 130, 140, 150 without leaving sink marks on the first surface 112 of the first workpiece 110. The thickness 165 can directly correspond to the length and/or depth of the grooves 130, 140, 150. For example, the thickness 165 can be between approximately 10 μm and approximately 100 mm.

Any of the grooves 130, 140, 150 formed within the second workpiece 120 may be prefabricated prior to joining. Additionally the cast material 160 and/or the separate material 170 may be prefabricated onto or attached to the first workpiece 110.

### II. METHODS OF JOINING

The joining system 100 can be formed through a number of conventional forming processes such as, but not limited to, laser heating, induction heating, and ultrasonic welding. Each process is illustrated with one of the example grooves 130, 140, 150 described above. However, each process can utilize any of the aforementioned grooves to facilitate joining the workpieces 110, 120.

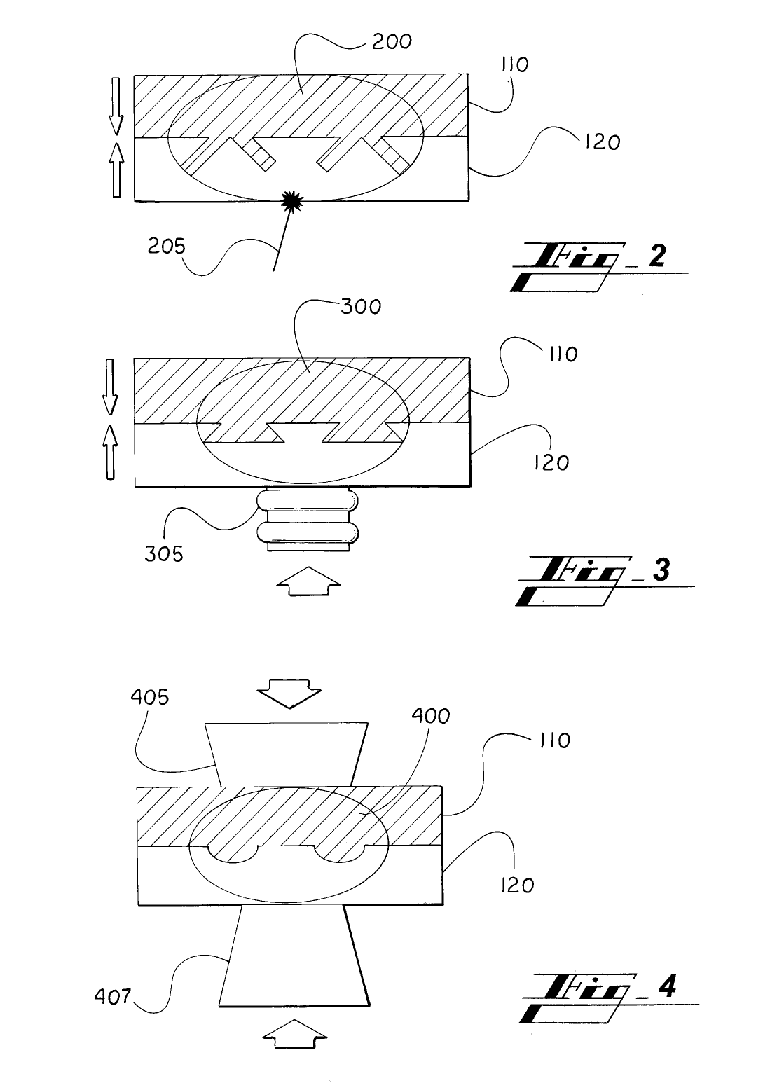

FIG. 2 illustrates joining of the first workpiece 110 and the second workpiece 120 using a laser heating process. The laser heating process is beneficial within high volume applications where short joining times are desired. Additionally, due to a concentrated heat footprint of lasers, the laser heating process may be utilized where joining needs to occur within a narrow space.

In the exemplary laser heating process, a joint is formed by compressing (compressional force denoted by arrows) the second surface 114 of the first workpiece 110 proximal to the first surface 122 of the second workpiece 120, having a melting temperature higher than that of the first workpiece 110. A laser beam 205 then provides concentrated heat on the second surface 124 of the second workpiece 120. Concentrated heating of the second workpiece 120 forms a laser weld area 200 (illustrated as an area within a circle in FIG. 2), which extends to the first workpiece 110 causing material of the first workpiece 110 to melt. Upon melting, compressional pressure—e.g., generated by clamping—forces the material of the first workpiece 110 to fill the slot grooves 130 within the second workpiece 120, thus forming the joint.

FIG. 3 illustrates joining of the first workpiece 110 and the second workpiece 120 using an induction heating process. The induction heating process is beneficial where the workpieces 110, 120 contain electrically conducting material (e.g., metal).

In the exemplary induction heating process, compressional force abuts the second surface 114 of the first workpiece 110, comprising thermoplastic materials, with the first surface 122 of the second workpiece 120, comprising conductive materials. An induction heater 305 (e.g., a heating coil) passes electrical current (e.g., eddy current) through the second workpiece 120 and resistance leads to heating of the second surface 124 of the second workpiece 120. Heating the second workpiece 120 forms an induction weld area 300 (illustrated as an area within a circle in FIG. 3), which extends to the first workpiece 110 causing the thermoplastic material to melt. Upon melting compressional pressure—e.g., generated by clamping—forces the thermoplastic material to fill the shaped grooves 140 within the second workpiece 120, forming the joint.

Alternatively, the induction heater 305 can generate heat using losses associated with magnetic hysteresis. Generating heat using losses from magnetic hysteresis may be beneficial were the material of the second workpiece 120 has permeability.

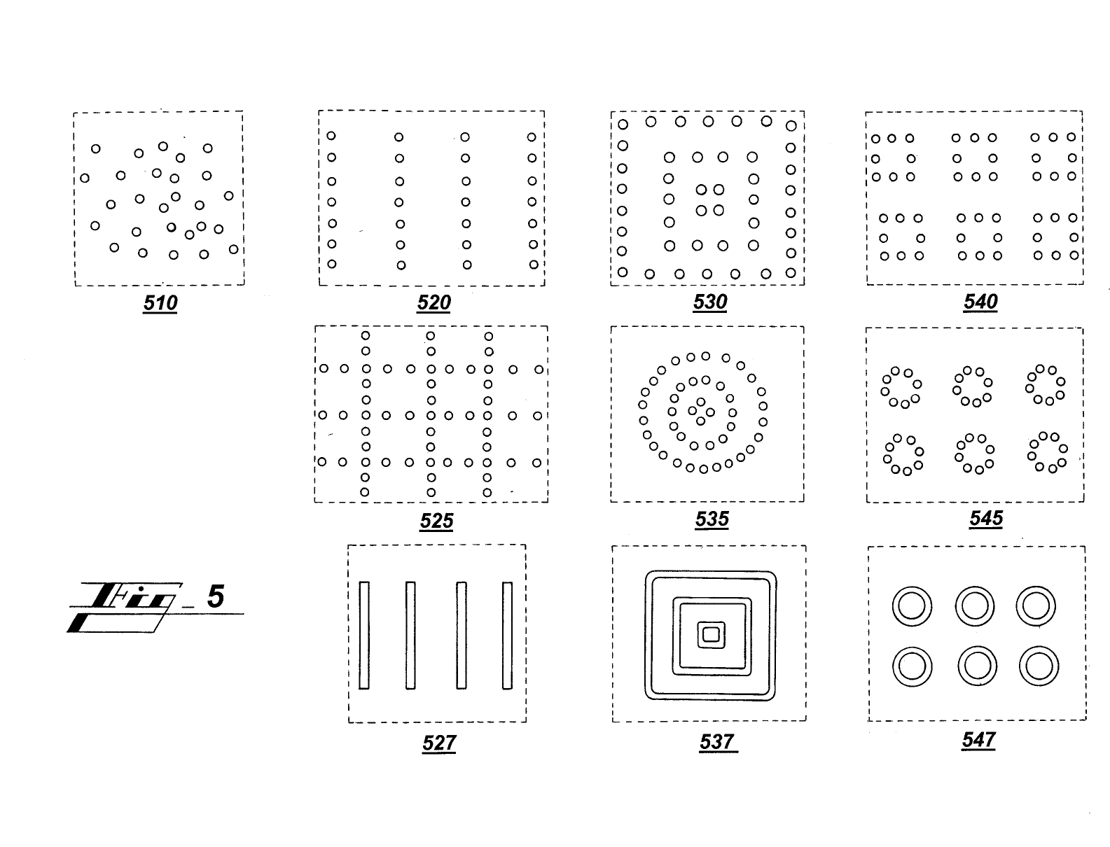

FIG. 4 illustrates joining of the first workpiece 110 and the second workpiece 120 using an ultrasonic welding process. The ultrasonic welding process may produce a joint with increased strength due to claiming force (denoted as arrows) by a weld horn 405 and an anvil 407. Ultrasonic welding may be used where visible welds are preferred.

In the exemplary ultrasonic process, compressional force of the weld horn 405 and the anvil 407 abuts the second surface 114 of the first workpiece 110 with the first surface 122 of the second workpiece 120. Vibrations from the weld horn 405 generating heat within the first surface 112 of the first workpiece 110, forming an ultrasonic weld area 400 (illustrated as an area within a circle in FIG. 4). Heat within the ultrasonic weld area 400 melts the material of the first workpiece 110, which fills the etched grooves 150 within the second workpiece 120, forming the joint.

### III. PATTERNS

### FIG. 5

Within the joining system 100, the grooves 130, 140, 150 can produce the patterns seen within FIG. 5. Additionally or alternatively, the cast material 160 and/or the separate material can produce the patterns seen within FIG. 5. In some embodiments, the grooves 130, 140, 150 can produce a first pattern and the cast material 160/separate material 170 can form a second pattern, corresponding to the first pattern, which facilitates interlock of the first workpiece 110 and the second workpiece 120.

The joining system 100 as described above can include grooves 130, 140, 150 with random patterns on at least one of the workpieces 110, 120, as seen within a random distribution 510. Alternatively, the groves 130, 140, 150 may be formed within one of the workpieces 110, 120 in patterns which provide benefit to the joining application.

Patterns may provide additional strength within the joint where at least one surface of at least one of the workpieces 110, 120 contained curvilinear properties (e.g., the first workpiece 110 is curved). In one embodiment, the grooves 130, 140, 150 form a parallel line pattern 520, where the grooves 130, 140, 150 are spaced along a length and/or a width of at least one of the workpieces 110, 120. In one embodiment, the grooves 130, 140, 150 form a cross-hatch line pattern 525 to provide additional strength in more than one direction.

In one embodiment, the grooves 130, 140, 150 form a continuous line pattern 527. The continuous line pattern 527 can consist of parallel lines as seen in FIG. 5. The continuous line pattern can also form straight line patterns such as a cross-hatch, among others.

Additionally, patterns may be used to provide additional strength within the joint where at least one of the workpieces 110, 120 is geometrically shaped (e.g., the first workpiece 110 is circular). Patterns can be formed using geometric shapes such as squares, circles, ovals, and triangles, among others.

Geometric patterns can be concentric in nature as seen by a concentric square pattern 530 and a concentric circle pattern 535 of FIG. 5. Alternatively, geometric patterns can be independent in nature as seen by an independent square pattern 540 and an independent circle pattern 545.

In one embodiment, the grooves 130, 140, 150 form a continuous concentric pattern 537 or a continuous independent pattern 547. The continuous concentric pattern 537 and the continuous independent pattern 547 can form any number of geometric shapes as mentioned above.

Other patterns are possible and may be preferred to a system designer depending on the application.

### IV. SELECT FEATURES OF THE PRESENT TECHNOLOGY

Many features of the present technology are described herein above. The present section presents in summary some selected features of the present technology. The present section highlights only a few of the many features of the technology and the following paragraphs are not meant to be limiting.

One benefit of the present technology is the workpieces are joined robustly through mechanical interlock provided by grooves formed on a joining surface of at least one workpiece. Mechanical interlock occurs through forming grooves on the workpiece(s) at the joining surface, which can improve joint strength, such as peel strength, over workpieces joined without grooves.

Another benefit of the present technology is physical properties of the grooves can be altered for a specific joining application. The size, shape, and depth of the grooves can be varied according to design requirements such as strength or required joining speed. Additionally, the grooves can be formed in patterns within the workpiece according to design requirements and/or workpiece shape.

Another benefit of the present technology is the mechanical interlocking at the joint surface can be accomplished without using separate mechanical interlocking items such as adhesives, rivets, or bolts. Eliminating the need for separate mechanical interlocking items can reduce the weight of the joint and provide a smooth joint surface, uninterrupted by bolt/rivet heads.

Another benefit of the present technology is the smooth joint surface is accomplished through one-sided joining. One-sided joining leaves no visible appearance impact on the workpiece surfaces opposite the joint surface. Eliminating visible impact on the workpieces allows freedom of joint design and application design freedom.

### IV. CONCLUSION

Various embodiments of the present disclosure are disclosed herein. The disclosed embodiments are merely examples that may be embodied in various and alternative forms, and combinations thereof.

Variations, modifications, and combinations may be made to the above-described embodiments without departing from the scope of the claims. All such variations, modifications, and combinations are included herein by the scope of this disclosure and the following claims.

1. A method, for forming a joint surface between a first workpiece and a second workpiece, comprising:
providing a second surface, opposite a first surface, of the first workpiece in contact with a first surface, opposite a second surface, of the second workpiece, the first surface of the second workpiece having formed therein a slot groove positioned at an angle between 0 degrees and 90 degrees relative to the first surface of the second workpiece, wherein the slot groove is sized and shaped to receive molten workpiece material from the first workpiece, when energy is applied to at least one of the first workpiece and the second workpiece, thereby enhancing interlock between the first workpiece and the second workpiece so that the joint surface formed can withstand a higher amount of fracture energy after a joint is formed than if the slot groove were not present;
applying energy to at least one of the first workpiece and the second workpiece causing material of the first workpiece to melt, yielding the molten workpiece material, and flow into the slot groove formed in the first surface of the second workpiece; and
allowing or causing the molten workpiece material to cool, forming an interlocking weld comprising the slot groove and joining the first workpiece to the second workpiece.

2. The method of claim 1 wherein forming the joint surface further comprises forming the slot groove mechanically, electrically, or by chemically etching into the first surface of the second workpiece.

3. The method of claim 1 wherein the angle is between 60 degrees and 30.

4. The method of claim 1 wherein:
the first surface of the second workpiece has a plurality of slot grooves formed therein;
a first of the slot grooves has a side extending at a first angle between 0 degrees and 90 degrees relative to the first surface of the second workpiece, in a reference frame, and a second of the slot grooves has a side extending at a second angle between 90 degrees and 180 degrees relative to the first surface of the second workpiece in the reference frame; and
energy applied, in forming the system, comprises melting the material of the first workpiece causing it to flow into each of the slot grooves formed in the first surface of the second workpiece forming the interlocking weld joining the first workpiece to the second workpiece.

5. The method of claim 1 wherein:
the first workpiece comprises, prior to the energy being applied, a protrusion extending from the second surface opposite the slot groove in the first surface of the second workpiece; and
energy applied, in forming the joint surface, to melt the material of the first workpiece comprises melting at least a portion of the protrusion so that it flows into the slot groove toward forming the interlocking weld joining the first workpiece to the second workpiece.

6. The method of claim 1 wherein applying energy, in forming the joint surface, to melt the material of the first workpiece comprises one of applying a laser to melt the material of the first workpiece, applying induction to melt the material of the first workpiece, and applying ultrasonic vibrations to melt the material of the first workpiece.

7. A system comprising:
a first workpiece comprising a first surface and a second surface opposite the surface; and
a second workpiece comprising a first surface connected by an interlocking weld with the second surface of the first workpiece and having formed therein a groove forming part of the interlocking weld;
wherein the system is formed by:
providing the second surface of the first workpiece in contact with surface of the second workpiece;
applying energy to at least one of the first workpiece and the second workpiece causing material of the first workpiece to melt, yielding molten and flow into the groove formed in the first surface of the second workpiece; and
allowing or causing the molten material to cool, forming the interlocking weld joining the first workpiece to the second workpiece.

8. The system of claim 7 wherein forming the system further comprises forming the groove mechanically, electrically, or by chemically etching into the first surface of the second workpiece.

9. The system of claim 7 wherein the groove extends at an angle between 90 degrees and 0 degrees to the first surface of the second workpiece.

10. The system of claim 7 wherein:
the first surface of the second workpiece has a plurality of grooves formed therein;
a first of the grooves has a side extending at a first angle between 0 degrees and 90 degrees from the first surface of the second workpiece, in a reference frame, and a second of the grooves has a side extending at a second angle between 90 degrees and 180 degrees from the first surface of the second workpiece in the reference frame; and
energy applied, in forming the system, comprises melting the material of the first workpiece causing it to flow into each of the grooves formed in the first surface of the second toward forming the interlocking weld joining the first workpiece to the second workpiece.

11. The system of claim 7 wherein:
the grooves have a first wall and a second wall;
at least a portion of the first wall extends at a first angle between 0 degrees and 90 degrees from the first surface of the second workpiece, in a reference frame; and
at least a portion of the second wall extends at a second angle between 90 degrees and 180 degrees from the first surface of the second workpiece in the reference frame.

12. The system of claim 7 wherein:
the first workpiece comprises, prior to the energy being applied, a protrusion extending from the second surface opposite the groove in the first surface of the second workpiece; and
energy applied, in forming the system, to melt the material of the first workpiece comprises melting at least a portion of the protrusion so that it flows into the groove toward forming the interlocking weld joining the first workpiece to the second workpiece.

13. The system of claim 7 wherein applying energy, in forming the system, to melt the material of the first workpiece comprises one of applying a laser to melt the material of the first workpiece, applying induction to melt the material of the first workpiece, and applying ultrasonic vibrations to melt the material of the first workpiece.

14. A system comprising:
a first workpiece comprising a first surface and a second surface opposite the first surface; and
a second workpiece comprising a first surface connected by an interlocking weld with the second surface of the first workpiece and having formed therein a groove forming part of the interlocking weld;
wherein the system is formed by:
providing the second surface of the first workpiece in contact with the first surface of the second workpiece;
applying energy to, at least one of the first workplace and the second workpiece causing material of the first workpiece to melt, yielding molten material, and wall material of the groove formed in the first surface of the second workplace to soften, yielding softened material; and
allowing or causing the molten material of the first workpiece to flow into the groove of the second workpiece; and
allowing or causing the molten material of the first workpiece and the softened material of the groove of the second workpiece to cool, forming the interlocking weld joining the first workpiece to the second workpiece.

15. The system of claim 14 wherein the wall material is softened, in forming the system, by the molten material flowing into the groove.

16. The system of claim 14 wherein at least some of the wall material is softened, in forming the system, before the molten material flows in the groove.

17. The system of claim 14 wherein:
the first surface of the second workpiece has a plurality of grooves formed therein;
a first of the grooves has a side extending at a first angle between 0 degrees and 90 degrees from the first surface of the second workplace, in a reference frame, and a second of the grooves has a side extending at a second angle between 90 degrees and 180 degrees from the first surface of the second workpiece in the reference frame; and
allowing or causing the molten material of the first workpiece to flow into the groove of the second workpiece, in forming the system, comprises allowing or causing the molten material to flow into each of the grooves formed in the first surface of the second toward forming the interlocking weld joining the first workpiece to the second workpiece.

18. The system of claim 14 wherein the groove has a first wall at least a portion of which extends at a first angle between 0 degrees and 90 degrees from the first surface of the second workpiece in a reference frame, and a second wall at least a portion of which extends at a second angle between 90 degrees and 180 degrees from the first surface of the second workpiece in the reference frame.

19. The system of claim 14 wherein:
the first workpiece comprises, prior to the energy being applied, a protrusion extending from the second surface opposite the groove in the first surface of the second workpiece; and
energy applied, in forming the system, to melt the material of the first workpiece comprises melting at least a portion of the protrusion so that it flows into the groove toward forming the interlocking weld joining the first workpiece to the second workpiece.

20. The system of claim 14 wherein applying the energy, in forming the system, to melt the material of the first workpiece comprises one of applying a laser to melt the material of the first workpiece, applying induction to melt the material of the first workpiece, and applying ultrasonic vibrations to melt the material of the first workpiece.
